(19) United States
(12) Patent Application Publication
(10) Pub. No.: US 2009/0241832 A1
(43) Pub. Date: Oct. 1, 2009

(54) COATING MECHANISM AND DROPLET JETTING DEVICE

(76) Inventor: Takashi HIRAKAWA, Kanagawa (JP)

Correspondence Address: BIRCH STEWART KOLASCH & BIRCH, PO BOX 747, FALLS CHURCH, VA, 22040-0747, US

(21) Appl. No.: 12/412,000

(22) Filed: Mar. 26, 2009

(30) Foreign Application Priority Data
Mar. 28, 2008 (JP) 2008-088455

(51) Int. Cl. B05C 11/00; B05C 1/08

(52) U.S. Cl. 118/688; 118/258

(57) ABSTRACT

A coating mechanism is provided with a supply roller that rotates in contact with, and applies treatment liquid to, conveyed paper. A control section controls the rotational velocity of the supply roller such that the rotational velocity when applying the treatment liquid to a first sheet of paper after commencement of application of the treatment liquid is slower than the rotational velocity when applying the treatment liquid to a second sheet of paper. An increase in the coating amount caused by an initialization operation is offset by a reduction in the amount of treatment liquid supplied caused by decreasing the rotational velocity of the supply roller, thereby inhibiting the occurrence of a disparity between the coating amount of treatment liquid applied to the first sheet of paper after commencement of treatment liquid application and the coating amount of treatment liquid applied to the second sheet of paper.

### CROSS-REFERENCE TO RELATED APPLICATION

This application claims priority under 35 USC 119 from Japanese Patent Application No. 2008-088455, the disclosure of which is incorporated by reference herein.

### BACKGROUND OF THE INVENTION

1. Field of the Invention

The present invention relates to a coating mechanism that applies a treatment liquid to an article that is to be coated (hereinafter, a “coating target”).

2. Description of the Related Art

A liquid coating mechanism used in an inkjet recording device that records an image on a recording medium by jetting ink is known as a coating mechanism that applies a treatment liquid to a coating target. With a liquid coating mechanism used in an inkjet recording device, a treatment liquid is, for example, applied to (coated on) a recording medium before ink is jetted onto the recording medium and ink is aggregated by the action of the treatment liquid, whereby image defects such as ink bleeding are suppressed.

The liquid coating mechanism disclosed in Japanese Patent Application Laid-open (JP-A) No. 2007-117806 is known as this kind of liquid coating mechanism. The liquid coating mechanism disclosed in JP-A No. 2007-117806 is provided with a means for selecting whether or not to apply a liquid based on the type of paper, in which a coating cap that supplies the liquid to a coating roller is configured so as to be removable therefrom, such that the coating cap is disengaged from the coating roller when liquid is not to be applied to the paper, and the coating cap is contacted against the coating roller when liquid is to be applied.

When different treatment liquids are to be coated on respective recording media, disparities are generated in terms of the extent of the reaction of the respective treatment liquids with the ink, and the size, depth, density and the like of the dots that are formed differ, causing variations in image quality.

In particular, directly after the initiation of application of the treatment liquid, the treatment liquid on the coating roller or the treatment liquid at the nip position (liquid well) between the coating roller and the conveyance drum disposed in opposition thereto is not yet in a stabilized state. Accordingly, there are cases when there is a difference between the amount of the treatment liquid applied to the first sheet of the recording medium after commencement of application of the treatment liquid and the amount of the treatment liquid applied to the second and subsequent sheets of the recording medium after commencement of application.

### SUMMARY OF THE INVENTION

In view of the foregoing circumstances, the present invention suppresses variation in the coating amount of a treatment liquid applied to a coating target.

A coating mechanism according to a first aspect of the present invention includes: a transport body that conveys a coating target; and a supply roller that rotates and supplies a treatment liquid toward the transport body in order to apply the treatment liquid to the coating target conveyed by the transport body, the supply roller performing an initialization operation prior to commencement of application of the treatment liquid by rotating and forming a liquid film of the treatment liquid on a surface of the supply roller, and a rotational velocity of the supply roller when applying the treatment liquid to a first coating target subsequent to the commencement of application of the treatment liquid being slower than a rotational velocity of the supply roller when applying the treatment liquid to a second coating target subsequent to the commencement of application of the treatment liquid.

In this configuration, the transport body conveys the coating target and the supply roller rotates and supplies the treatment liquid toward the transport body in order to apply the treatment liquid to the coating target being conveyed by the transport body.

In the configuration according to the first aspect of the present invention, the supply roller performs an initialization operation prior to commencement of application of the treatment liquid by rotating and forming a liquid film of the treatment liquid on a surface of the supply roller. Further, the rotational velocity of the supply roller when applying the treatment liquid to the first coating target after commencement of application of the treatment liquid is slower than the rotational velocity of the supply roller when applying the treatment liquid to the second coating target after commencement of application of the treatment liquid.

When the supply roller performs the initialization operation, the coating amount applied to the first coating target after commencement of coating is larger than the coating amount applied to the second coating target after commencement of coating; however, in this configuration, the rotational velocity of the supply roller when coating the first coating target after commencement of coating is made slower than the rotational velocity of the supply roller when coating the second coating target after commencement of coating. Accordingly, the amount of treatment liquid supplied to the transport body when coating the first coating target after commencement of coating is smaller than the amount of treatment liquid supplied to the transport body when coating the second coating target after commencement of coating.

As a result, the increase in the coating amount caused by the initialization operation of the supply roller is offset by the reduction in the supply amount of treatment liquid caused by decreasing the rotational velocity of the supply roller, thereby inhibiting the occurrence of a disparity between the coating amount of treatment liquid applied to the first coating target after commencement of coating and the coating amount of treatment liquid applied to the second coating target after commencement of coating.

In this way, according to the first aspect of the present invention, variation in the coating amount of treatment liquid applied to the coating target can be suppressed.

In the configuration according to the first aspect of the present invention, the rotational velocity of the supply roller when applying the treatment liquid to the first coating target after commencement of application of the treatment liquid may be gradually increased.

According to this configuration, since the rotational velocity of the supply roller when applying the treatment liquid to the first coating target after commencement of application of the treatment liquid gradually increases, variation in the coating amount applied to respective portions of the first coating target after commencement of coating can be suppressed.

In the coating mechanism according to the first aspect of the present invention, the rotational velocity of the supply roller may be varied in accordance with the permeability of the coating target with respect to the treatment liquid.

According to this configuration, since the rotational velocity is varied in accordance with the permeability of the coating target with respect to the treatment liquid, variation in the coating amount can be suppressed even when the permeability of the coating target differs.

In the coating mechanism according to the first aspect of the present invention, the supply roller may rotate in the opposite direction to the conveyance direction of the coating target to supply the treatment liquid to the transport body, and the rotational velocity of the supply roller may be faster than the conveyance velocity of the transport body.

According to this configuration, since the supply roller rotates in the opposite direction to the conveyance direction of the coating target to supply the treatment liquid to the transport body, formation of waves or the like in the coating target being conveyed does not arise.

Further, since the rotational velocity of the supply roller is faster than the conveyance velocity of the transport body, liquid deficit does not occur at the transport body and variation in the coating amount applied to the coating target can be suppressed.

The coating mechanism according to the first aspect of the present invention may also include a detector that detects the amount of treatment liquid in a liquid well formed between the transport body and the supply roller, such that the rotational velocity of the supply roller changes in accordance with the amount of treatment liquid in the liquid well detected by the detector.

According to this configuration, the detector detects the amount of treatment liquid in a liquid well formed between the transport body and the supply roller, and the rotational velocity of the supply roller is changed in accordance with the result of the detection by the detector.

As a result, the coating amount of treatment liquid applied to the coating target can be adjusted and variation in the coating amount applied to the coating target can be suppressed.

A coating mechanism according to a second aspect of the present invention includes: a transport body that conveys a coating target; a supply roller that rotates and supplies a treatment liquid toward the transport body in order to apply the treatment liquid to the coating target conveyed by the transport body; and an intermediate roller disposed between the transport body and the supply roller and that supplies the treatment liquid, which is supplied from the supply roller, to the transport body, the intermediate roller performing an initialization operation prior to commencement of application of the treatment liquid by rotating and forming a liquid film of the treatment liquid on a surface of the intermediate roller, and a rotational velocity of the intermediate roller being slower than a rotational velocity of the supply roller, and a rotational velocity of the supply roller when applying the treatment liquid to a first coating target subsequent to the commencement of application of the treatment liquid being slower than a rotational velocity of the supply roller when applying the treatment liquid to a second coating target subsequent to the commencement of application of the treatment liquid.

According to this configuration, the transport body conveys the coating target and the supply roller rotates and supplies the treatment liquid toward the transport body in order to apply the treatment liquid to the coating target being conveyed by the transport body.

In the configuration according to the second aspect of the present invention, the intermediate roller performs an initialization operation prior to commencement of application of the treatment liquid by rotating and forming a liquid film of the treatment liquid on a surface of the intermediate roller. Further, the rotational velocity of the supply roller when applying the treatment liquid to the first coating target after commencement of application of the treatment liquid is slower than the rotational velocity of the supply roller when applying the treatment liquid to the second coating target after commencement of application of the treatment liquid.

When the intermediate roller performs the initialization operation, the coating amount applied to the first coating target after commencement of coating is larger than the coating amount applied to the second coating target after commencement of coating; however, in this configuration, the rotational velocity of the supply roller when coating the first coating target after commencement of coating is made slower than the rotational velocity of the supply roller when coating the second coating target after commencement of coating. Accordingly, the amount of treatment liquid supplied to the transport body when coating the first coating target after commencement of coating is smaller than the amount of treatment liquid supplied to the transport body when coating the second coating target after commencement of coating.

As a result, the increase in the coating amount caused by the initialization operation of the intermediate roller is offset by the reduction in the supply amount of treatment liquid caused by decreasing the rotational velocity of the supply roller, thereby inhibiting the occurrence of a disparity between the coating amount of treatment liquid applied to the first coating target after commencement of coating and the coating amount of treatment liquid applied to the second coating target after commencement of coating.

In this way, according to the second aspect of the present invention, variation in the coating amount of treatment liquid applied to the coating target can be suppressed.

Further, according to the second aspect of the present invention, the rotational velocity of the intermediate roller, which supplies treatment liquid, which has been supplied from the supply roller, to the transport body, is slower than the rotational velocity of the supply roller. That is, liquid deficit does not occur at the roller being supplied with the treatment liquid (intermediate roller) and variation in the coating amount applied to the coating target can be suppressed.

A liquid jetting device according to a third aspect of the present invention is provided with a coating mechanism according to either of the above first and second aspects of the present invention.

Due to the above configuration of the present invention, variation in the coating amount of treatment liquid applied to a coating target can be suppressed.

### BRIEF DESCRIPTION OF THE DRAWINGS

Exemplary embodiments of the invention will be described in detail with reference to the following figures, wherein:

FIG. 1 is a schematic diagram showing the configuration of a coating mechanism according to the present exemplary embodiment;

FIGS. 2A and 2B are graphs showing a comparison of the coating thickness (coating amount) of treatment liquid on respective sheets of paper in a case in which the treatment liquid is applied to plural sheets of paper, with the rotational velocity of the supply roller kept constant, after an initialization operation is performed;

FIGS. 3A and 3B are graphs showing a comparison of the coating thickness (coating amount) of treatment liquid on respective sheets of paper in a case in which the treatment liquid is applied to plural sheets of paper, with the rotational velocity of the supply roller kept constant, when an initialization operation is not performed;

FIG. 4 is a graph showing the relationship between the rotational velocity of the supply roller and the coating thickness (coating amount) on paper;

FIGS. 5A and 5B are graphs showing a comparison of the coating thickness (coating amount) of treatment liquid on respective sheets of paper in a case in which the rotational velocity of the supply roller is controlled according to Example 1;

FIGS. 6A and 6B are graphs showing a comparison of the coating thickness (coating amount) of treatment liquid on respective sheets of paper in a case in which the rotational velocity of the supply roller is controlled according to Example 2;

FIGS. 7A and 7B are graphs showing a comparison of the coating thickness (coating amount) of treatment liquid on respective sheets of paper in a case in which the rotational velocity of the supply roller is controlled according to Example 3;

FIG. 8 is a graph showing a comparison of the coating thickness (coating amount) of treatment liquid on respective sheets of paper in a case in which, after an initialization operation is performed, the rotational velocity of the supply roller is kept constant and treatment liquid is applied to plural sheets of paper having different permeability;

FIGS. 9A and 9B are graphs showing a comparison of the coating thickness (coating amount) of treatment liquid on respective sheets of paper P in a case in which, for paper having comparatively favorable permeability, the rotational velocity of the supply roller is made relatively slow and treatment liquid is applied to plural sheets of the paper and, for paper having comparatively poor permeability, the rotational velocity of the supply roller is made relatively fast and treatment liquid is applied to plural sheets of the paper;

FIG. 10 is a schematic view showing a configuration in which plural rollers for supplying treatment liquid to a carrier drum are provided;

FIGS. 11A and 11B are graphs showing a comparison of the coating thickness (coating amount) of treatment liquid on respective sheets of paper in a case in which, in the configuration shown in FIG. 10, the rotational velocity of the supply roller is controlled;

FIG. 12 is a schematic view showing a configuration in which, in the configuration shown in FIG. 1, the supply roller is rotated in the opposite direction; and

FIG. 13 is a schematic view showing a configuration in which the amount of liquid in the liquid well according to the present embodiment is detected.

### DETAILED DESCRIPTION OF THE INVENTION

In the following, an exemplary embodiment of the present invention is explained based on the drawings.

### Configuration of Coating Mechanism according to Present Exemplary Embodiment

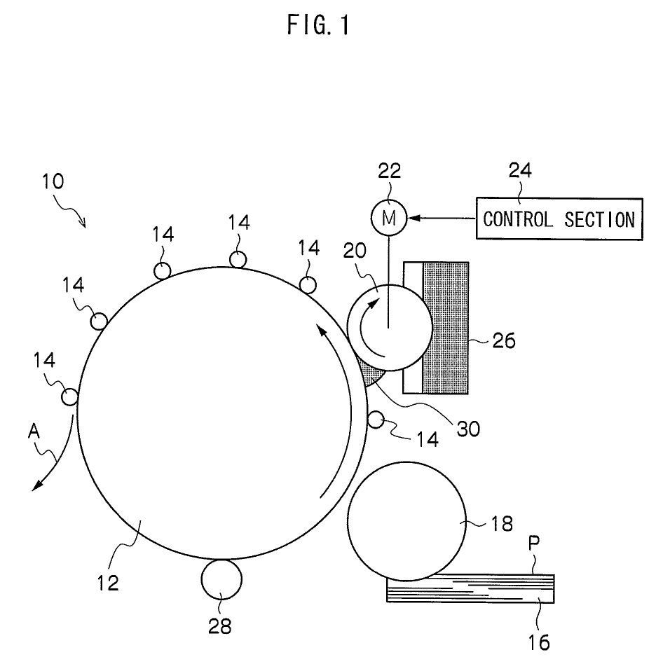

First, the configuration of a coating mechanism according to the present exemplary embodiment is explained. FIG. 1 is a schematic diagram showing the configuration of a coating mechanism according to the present exemplary embodiment.

Coating mechanism 10 according to the present exemplary embodiment is a coating mechanism that applies a treatment liquid to paper P, which is one example of a coating target and is used, for example, in a droplet jetting device that jets droplets of a liquid. Examples of a droplet jetting device include an inkjet recording device that records an image by jetting ink onto a recording medium such as paper. Further, the coating target is not limited to paper P and may be, for example, a fabric or other sheet-shaped member.

As shown in FIG. 1, coating mechanism 10 according to the present exemplary embodiment is provided with transport drum 12, which is one example of a transport body that conveys a coating target and which conveys paper P. Further, coating mechanism 10 according to the present exemplary embodiment is provided with paper container 16 that stores paper P and feed roller 18 that feeds paper P from container 16 to transport drum 12. In addition, plural holding rollers 14 are disposed in opposition to transport drum 12 around the periphery thereof. Holding rollers 14 are one example of a holding member that holds paper P at the surface (outer peripheral surface) of transport drum 12. Holding rollers 14 hold paper P by pressing paper P against transport drum 12.

According to the above configuration, paper P stored in container 16 is fed from container 16 to transport drum 12 by feed roller 18. When fed to transport drum 12, paper P is held at transport drum 12 by holding rollers 14 and conveyed by transport drum 12. After being conveyed by transport drum 12, paper P is transferred to another transport body (not shown) at a given position (refer to arrow A in FIG. 1) and ink is jetted onto paper P from an inkjet recording head (not shown) and an image recorded thereon while paper P is conveyed by the other transport body.

The transport body that conveys the coating target is not limited to transport drum 12 and may be a conveyor belt or the like. Further, the holding member that holds paper P at the surface (outer peripheral surface) of transport drum 12 may be, for example, a clip that is provided at transport drum 12 and that holds the leading edge of paper P. In addition, a mechanism that holds paper P at the surface (outer peripheral surface) of transport drum 12 by electrostatic or negative pressure attraction may be employed as the holding mechanism that holds paper P at the surface (outer peripheral surface) of transport drum 12.

Downstream of feed roller 18 in the direction of rotation of transport drum 12, supply roller 20, which rotates to supply treatment liquid toward transport drum 12, is provided in order to apply treatment liquid to paper P being conveyed by transport drum 12.

Drive motor 22, which is a driving section that drives supply roller 20, is provided at supply roller 20. Supply roller 20 is imparted with drive force by drive motor 22 and rotates in the opposite direction to transport drum 12. In other words, transport drum 12 in FIG. 1 rotates in an anticlockwise direction while supply roller 20 rotates in a clockwise direction. As a result, supply roller 20 rotates in accordance with the direction of conveyance of paper P.

Control section 24 that controls the driving is connected to drive motor 22, and control section 24 is configured so as to control the rotational velocity of supply roller 20 by controlling the motor rotational frequency of drive motor 22.

In addition, coating mechanism 10 is provided with a reservoir 26 that stores treatment liquid and which is one example of a supply means that supplies treatment liquid to supply roller 20. Treatment liquid is supplied to supply roller 20 by immersion of supply roller 20 in the treatment liquid in reservoir 26 and absorption of the treatment liquid in reservoir 26 by supply roller 20.

The treatment liquid exhibits the effect of aggregating, at the treatment liquid, dye (pigment) and latex particles dispersed in the ink, whereby an aggregate body is formed on the paper P in which dye running or the like does not occur. One example of the reaction between the ink and the treatment liquid is a case in which the treatment liquid includes an acid and a mechanism is employed in which the pigment dispersion is dismantled by lowering the pH, followed by aggregation, whereby interference between droplets upon impact, caused by dye bleeding, color mixing between different colored inks and liquid coalescence at the time of ink droplet impact, is avoided.

In the present exemplary embodiment, supply roller 20 rotates in contact with transport drum 12, thereby supplying treatment liquid to transport drum 12. Specifically, liquid well 30 is formed by the treatment liquid between supply roller 20 and transport drum 12 and treatment liquid is supplied to liquid well 20. Treatment liquid is applied to paper P as a result of the passage of paper P through liquid well 30.

Further, downstream of the given position (refer to arrow A in FIG. 1) at which paper P is transferred to the other transport body (not shown) and upstream of feed roller 18 in the direction of rotation of transport drum 12, cleaning roller 28 is provided, which cleans off treatment liquid attached to transport drum 12.

### Control of the Rotational Velocity of Supply Roller 20

Next, explanation is given regarding control of the rotational velocity of supply roller 20.

The following two issues are pertinent to the control of the rotational velocity of supply roller 20.

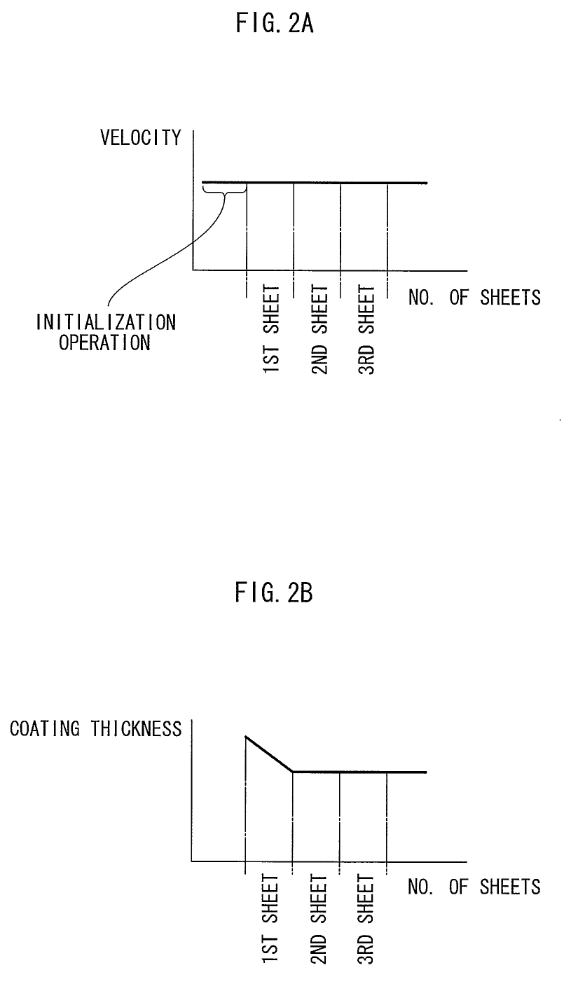

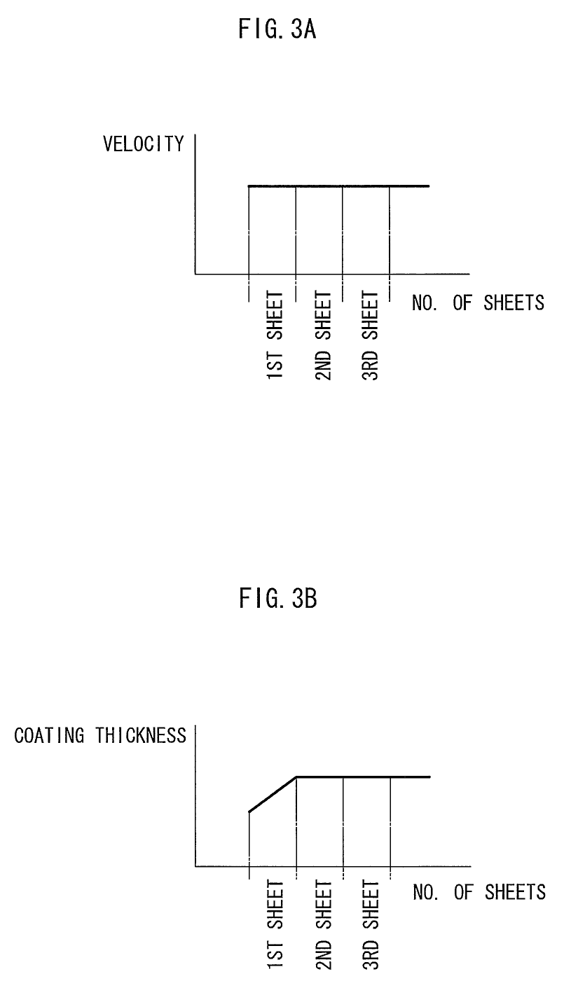

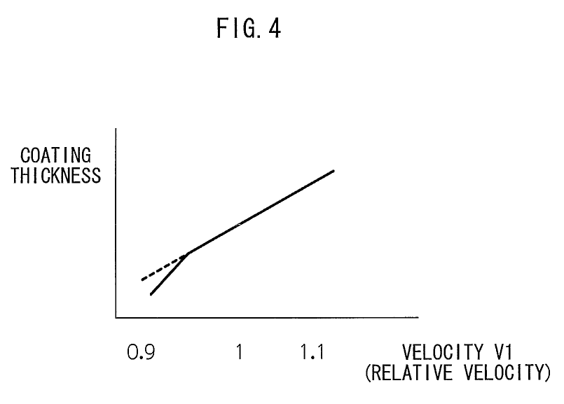

FIGS. 2A and 2B are graphs showing a comparison of the coating thickness (coating amount) of treatment liquid on respective sheets of paper P in a case in which the treatment liquid is applied to plural sheets of paper P, with the rotational velocity of the supply roller kept constant, after an initialization operation is performed. FIGS. 3A and 3B are graphs showing a comparison of the coating thickness (coating amount) of treatment liquid on respective sheets of paper P in a case in which the treatment liquid is applied to plural sheets of paper P, with the rotational velocity of the supply roller kept constant, when an initialization operation is not performed. In FIGS. 2A and 2B and FIGS. 3A and 3B, the vertical axis of FIGS. 2A and 3A shows the rotational velocity of the supply roller and the horizontal axis thereof shows the number of sheets of paper P from the commencement of coating, while the vertical axis of FIGS. 2B and 3B shows the coating thickness (coating amount) on paper P and the horizontal axis thereof shows the number of sheets of paper P from the commencement of coating (the values of the coating thickness and of the rotational velocity being relative values). FIG. 4 is a graph showing the relationship between the rotational velocity V1 of supply roller 20 and the coating thickness (coating amount) on paper P. In FIG. 4, the vertical axis shows the coating thickness (coating amount) on paper P and the horizontal axis shows the rotational velocity V1 of supply roller 20 (the values of the coating thickness and of the rotational velocity being relative values).

The first issue is that when, as shown in FIG. 2A, coating is performed with respect to plural sheets of paper P with the rotational velocity of the supply roller kept constant after an initialization operation has been performed, the coating thickness (coating amount) on the first sheet of paper P after commencement of coating is, as shown in FIG. 2B, larger than the coating thickness (coating amount) on the second and subsequent sheets of paper P after commencement of coating.

The initialization operation is an operation that rotates supply roller 20 through at least one rotation, in order that a liquid film is formed on the surface of supply roller 20 before the treatment liquid is applied to paper P. When, as shown in FIG. 3A, the initialization operation is not performed, the coating thickness on the first sheet after commencement of coating is, as shown in FIG. 3B, smaller than the coating thickness on the second and subsequent sheets of paper P after commencement of coating. The initialization operation has the effect of preventing the surface of supply roller 20 from drying and, further, if drying occurs, enables any dried precipitate to be re-dissolved by passing it through reservoir 26 again.

The second issue is that when the rotational velocity V1 of supply roller 20 is increased, the amount of treatment liquid supplied to transport drum 12 (liquid well 30) increases and, as shown in FIG. 4, the coating thickness on paper P increases. Further, when the rotational velocity V1 of supply roller 20 is decreased to a certain velocity or below, as evidenced by the solid line in the graph falling sharply with respect to the broken line, a shortage of treatment liquid occurs and the coating thickness on paper P rapidly decreases.

In the present exemplary embodiment, in view of these two issues, the rotational velocity of supply roller 20 is controlled as follows. That is, control section 24 controls the rotational velocity of supply roller 20 such that the rotational velocity V1 when applying the treatment liquid to the first sheet of paper P after commencement of application of the treatment liquid is slower than the rotational velocity V1 when applying the treatment liquid to the second sheet of paper P after commencement of application of the treatment liquid. In the following, specific examples are given of control of the rotational velocity V1 of supply roller 20.

### EXAMPLE 1

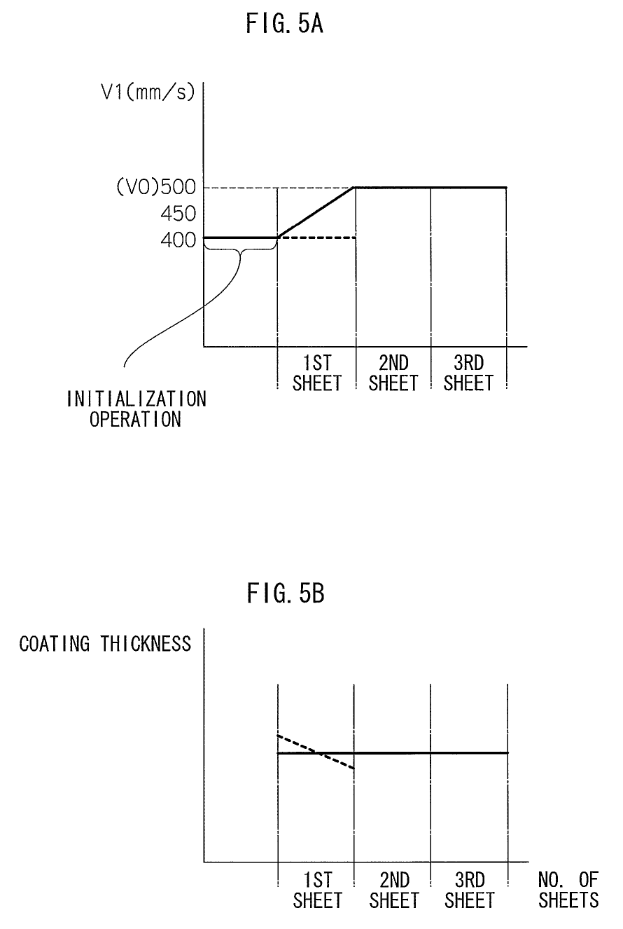

FIGS. 5A and 5B are graphs showing a comparison of the coating thickness (coating amount) of treatment liquid on respective sheets of paper P in a case in which the rotational velocity V1 of supply roller 20 is controlled according to Example 1. The vertical axis of FIG. 5A shows the rotational velocity V1 of supply roller 20 and the horizontal axis thereof shows the number of sheets P from the commencement of coating. The vertical axis of FIG. 5B shows the coating thickness (coating amount) on paper P and the horizontal axis thereof shows the number of sheets P from the commencement of coating (the value of the coating thickness being a relative value).

In Example 1, the rotational velocity V1 of supply roller 20 is set to be slower than the conveyance velocity V0 of transport drum 12 for the first sheet of paper P after commencement of coating, and the rotational velocity V1 of supply roller 20 is set to be equal to the conveyance velocity V0 of transport drum 12 for the second and subsequent sheets of paper P after commencement of coating. Further, the rotational velocity V1 of supply roller 20 with respect to the first sheet of paper P is shown with a broken line in FIG. 5A.

Specifically, for example: V1 (first sheet)=400 mm/s; V1 (second sheet)=V1 (third sheet)=[and so forth]=500 mm/s; and V0=500 mm/s.

In this way, by controlling the rotational velocity V1 of supply roller 20, the increase in the coating amount caused by the initialization operation of supply roller 20 is offset by the reduction in the supply amount of treatment liquid caused by decreasing the rotational velocity V1 of supply roller 20, thereby inhibiting the occurrence of a disparity between the amount of treatment liquid applied to the first sheet of paper P after commencement of coating and the amount of treatment liquid applied to the second sheet of paper P after commencement of coating. As a result, variation in the coating amount of treatment liquid applied to paper P can be suppressed.

Further, as shown by the solid line in FIG. 5A, the velocity of supply roller 20 with respect to the first sheet of paper P may be gradually increased.

In such a configuration, the rotational velocity V1 of supply roller 20 with respect to the leading end portion of the first sheet of paper P is set to be slower than the conveyance velocity V0 of transport drum 12, the rotational velocity V1 of supply roller 20 with respect to the intermediate portion of the first sheet of paper P is set to be slower than the conveyance velocity V0 of transport drum 12 and also faster than the rotational velocity V1 of supply roller 20 with respect to the leading end portion of the first sheet of paper P, and the rotational velocity V1 of supply roller 20 with respect to the rear end portion of the first sheet of paper P and the rotational velocity V1 of supply roller 20 with respect to the second and subsequent sheets of paper P is set to be equal to the conveyance velocity V0 of transport drum 12.

Specifically, for example: V1 (first sheet) leading end portion=400 mm/s; V1 (first sheet) intermediate portion=450 mm/s; V1 (first sheet) rear end portion=V1 (second sheet)=V1 (third sheet)=[and so forth]=500 mm/s; and V0=500 mm/s. As a result, variation in the coating amount of treatment liquid applied to respective portions of the first sheet of paper P after commencement of coating can be suppressed.

### EXAMPLE 2

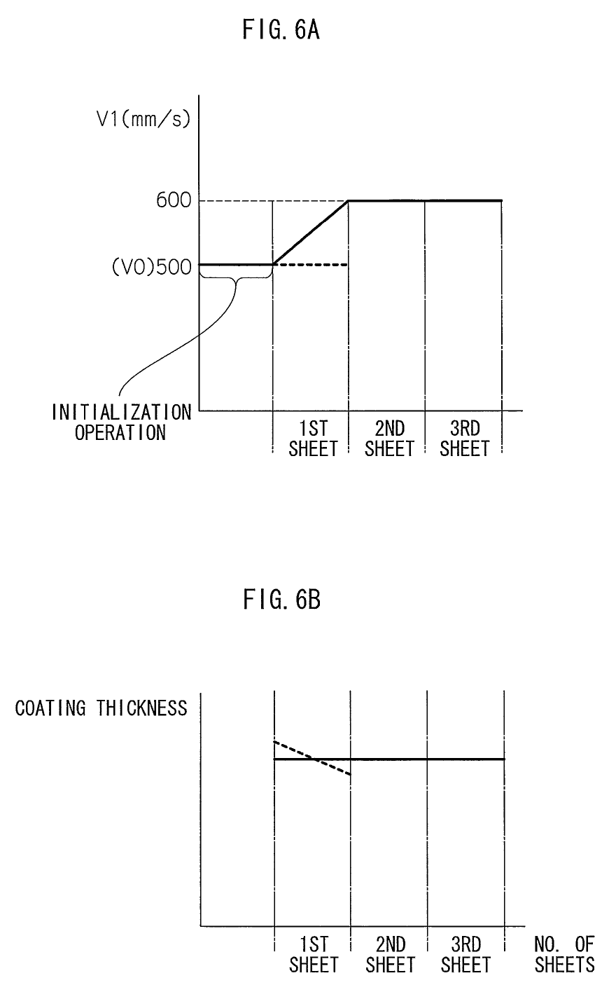

FIGS. 6A and 6B are graphs showing a comparison of the coating thickness (coating amount) of treatment liquid on respective sheets of paper P in a case in which the rotational velocity V1 of supply roller 20 is controlled according to Example 2. The vertical axis of FIG. 6A shows the rotational velocity V1 of supply roller 20 and the horizontal axis thereof shows the number of sheets P from the commencement of coating. The vertical axis of FIG. 6B shows the coating thickness (coating amount) on paper P and the horizontal axis thereof shows the number of sheets P from the commencement of coating (the value of the coating thickness being a relative value).

In Example 2, as shown in FIG. 6A, the rotational velocity V1 of supply roller 20 with respect to the first sheet of paper P is set to be equal to the conveyance velocity V0 of transport drum 12 and the rotational velocity V1 of supply roller 20 with respect to the second and subsequent sheets of paper P is set to be faster than the conveyance velocity V0 of transport drum 12. Further, in FIG. 6A, the rotational velocity V1 of supply roller 20 with respect to the first sheet of paper P is shown with a broken line

Specifically, for example: V1 (first sheet)=500 mm/s; V1 (second sheet)=V1 (third sheet)=[and so forth]=600 mm/s; and V0=500 mm/s.

In this way, by controlling the rotational velocity V1 of supply roller 20, the increase in the coating amount caused by the initialization operation of supply roller 20 is offset by the reduction in the supply amount of treatment liquid caused by decreasing the rotational velocity V1 of supply roller 20, thereby inhibiting the occurrence of a disparity between the amount of treatment liquid applied to the first sheet of paper P after commencement of coating and the amount of treatment liquid applied to the second sheet of paper P after commencement of coating. As a result, variation in the coating amount of treatment liquid applied to paper P can be suppressed.

Further, as shown by the solid line in FIG. 6A, the velocity of supply roller 20 with respect to the first sheet of paper P may be gradually increased.

In such a configuration, the rotational velocity V1 of supply roller 20 with respect to the leading end portion of the first sheet of paper P is set to be equal to the conveyance velocity V0 of transport drum 12, the rotational velocity V1 of supply roller 20 with respect to the intermediate portion of the first sheet of paper P is set to be faster than the rotational velocity V1 of supply roller 20 with respect to the leading end portion of the first sheet of paper P, and the rotational velocity V1 of supply roller 20 with respect to the rear end portion of the first sheet of paper P and the rotational velocity V1 of supply roller 20 with respect to the second and subsequent sheets of paper P is set to be faster than the rotational velocity V1 of supply roller 20 with respect to the intermediate portion of the first sheet of paper P.

Specifically, for example: V1 (first sheet) leading end portion=500 mm/s; V1 (first sheet) intermediate portion=550 mm/s; V1 (first sheet) rear end portion=V1 (second sheet)=V1 (third sheet)=[and so forth]=600 mm/s; and V0=500 mm/s.

As a result, variation in the coating amount of treatment liquid applied to respective portions of the first sheet of paper P after commencement of coating can be suppressed.

### EXAMPLE 3

However, when the rotational velocity V1 of supply roller 20 is made slower than the conveyance velocity V0 of transport drum 12, there is a risk that supply roller 20 will not be able to supply a sufficient amount of treatment liquid, causing a liquid deficit and resulting in unevenness of coating. This is particularly pronounced when the surface of supply roller 20 is smooth, but tends not to occur when supply roller is provided with grooves.

In contrast, when the rotational velocity V1 of supply roller 20 is made faster than the conveyance velocity V0 of transport drum 12, and when the rear end of paper P is not held, supply roller 20 rolls up the paper P generating waves in the paper P. This is particularly pronounced when supply roller 20 is a rubber roller and, in addition, transport drum 12 is made of a metal, and friction is generated. Accordingly, an effective way of eliminating both of these problems is to reduce the absolute value of the difference between the rotational velocity V1 of supply roller 20 and the conveyance velocity V0 of transport drum 12, as shown in the following.

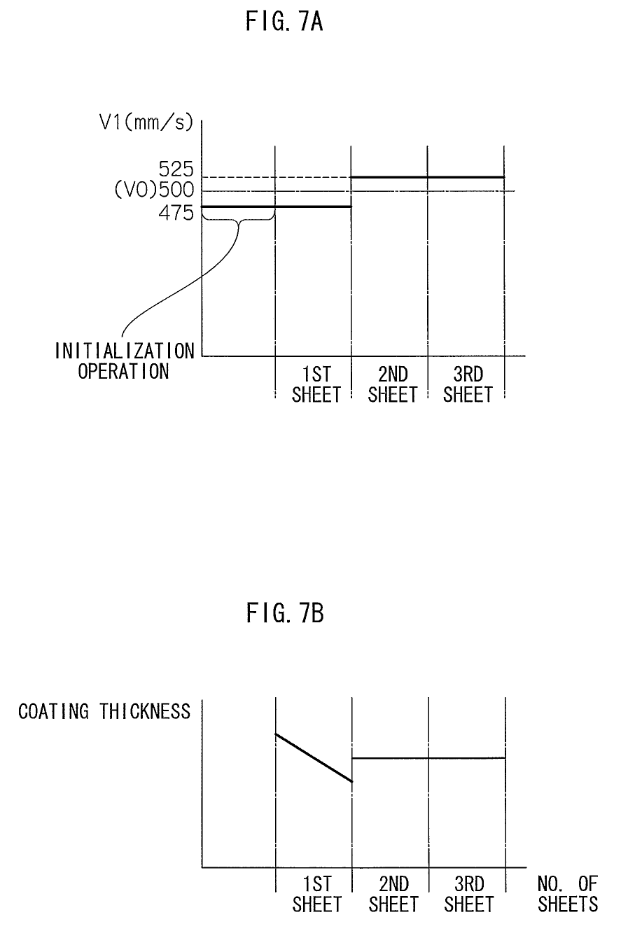

FIGS. 7A and 7B are graphs showing a comparison of the coating thickness (coating amount) of treatment liquid on respective sheets of paper P in a case in which the rotational velocity V1 of supply roller 20 is controlled according to Example 3. The vertical axis of FIG. 7A shows the rotational velocity V1 of supply roller 20 and the horizontal axis thereof shows the number of sheets P from the commencement of coating. The vertical axis of FIG. 7B shows the coating thickness (coating amount) on paper P and the horizontal axis thereof shows the number of sheets P from the commencement of coating (the value of the coating thickness being a relative value).

As shown in FIG. 7A, the rotational velocity V1 of supply roller 20 with respect to the first sheet of paper P after commencement of coating is set to be slower than the conveyance velocity V0 of transport drum 12, and the rotational velocity V1 of supply roller 20 with respect to the second and subsequent sheets of paper P after commencement of coating is set to be faster than the conveyance velocity V0 of transport drum 12.

Specifically, for example: V1 (first sheet)=475 mm/s; V1 (second sheet)=V1 (third sheet)=[and so forth]=525 mm/s; and V0=500 mm/s.

In this way, by controlling the rotational velocity V1 of supply roller 20, the increase in the coating amount caused by the initialization operation of supply roller 20 is offset by the reduction in the supply amount of treatment liquid caused by decreasing the rotational velocity V1 of supply roller 20, thereby inhibiting the occurrence of a disparity between the amount of treatment liquid applied to the first sheet of paper P after commencement of coating and the amount of treatment liquid applied to the second sheet of paper P after commencement of coating. As a result, variation in the coating amount of treatment liquid applied to paper P can be suppressed. In addition, the occurrence of coating unevenness caused by liquid deficit and the formation of waves in paper P are suppressed.

Further, in the foregoing explanation, the control of the rotational velocity of supply roller 20 that is performed in order to vary the supply amount of the treatment liquid is performed with respect to the relative velocity with respect to transport drum, but the velocity control may performed at the side of transport drum 12.

Accordingly, instead of a configuration in which the rotational velocity V1 of supply roller 20 is increased, a configuration may be adopted in which the conveyance velocity (rotational velocity) V0 of transport drum 12 is decreased. When the conveyance velocity V0 of the transport drum is changed, it is necessary to adapt the jetting timing of the inkjet recording head located downstream in the conveyance direction and, in such a case, control of the jetting timing of the inkjet recording head is performed based on the conveyance velocity of the transport drum. However, when the jetting frequency is altered, unevenness in the density of a solid image occurs, although slight. This is presumed to be due to the fact that because the timing of the coalescence of adjacent droplets jetted in the conveyance direction changes, the visual effect of the image varies as a result of a difference in the size of droplets that have permeated prior to coalescence and the size of droplets that have first coalesced. While it is possible to address the unevenness in density by controlling the print data signal and setting a jetting amount that does not generate unevenness in density, such control is complex.

Therefore, in order to ensure that jetting is not performed until coating is complete, the length of the conveyance path from the coating position at which the treatment liquid is applied to the inkjet recording head is made longer than the length of paper P. In this way, it is possible to perform jetting while conveying paper P at a constant speed and to form an image without unevenness in density.

Control of the Rotational Velocity V1 of Supply Roller 20 in Accordance with the Type of Paper P

Next, control of the rotational velocity V1 of supply roller 20 in accordance with the type of paper P is explained.

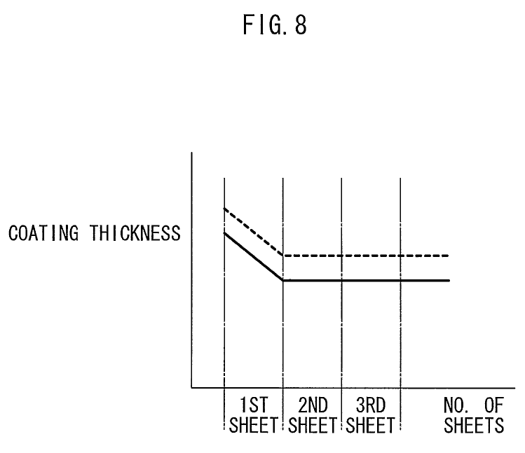

FIG. 8 is a graph showing a comparison of the coating thickness (coating amount) of treatment liquid on respective sheets of paper P in a case in which, after an initialization operation is performed, the rotational velocity of supply roller 20 is kept constant and treatment liquid is applied to plural sheets of paper having different permeability. In FIG. 8, the vertical axis represents the coating thickness (coating amount) and the horizontal axis represents the number of sheets of paper P from the commencement of coating (the value of the coating thickness being a relative value). Further, the solid line represents a paper P having comparatively favorable permeability while the broken line represents a paper P having comparatively poor permeability.

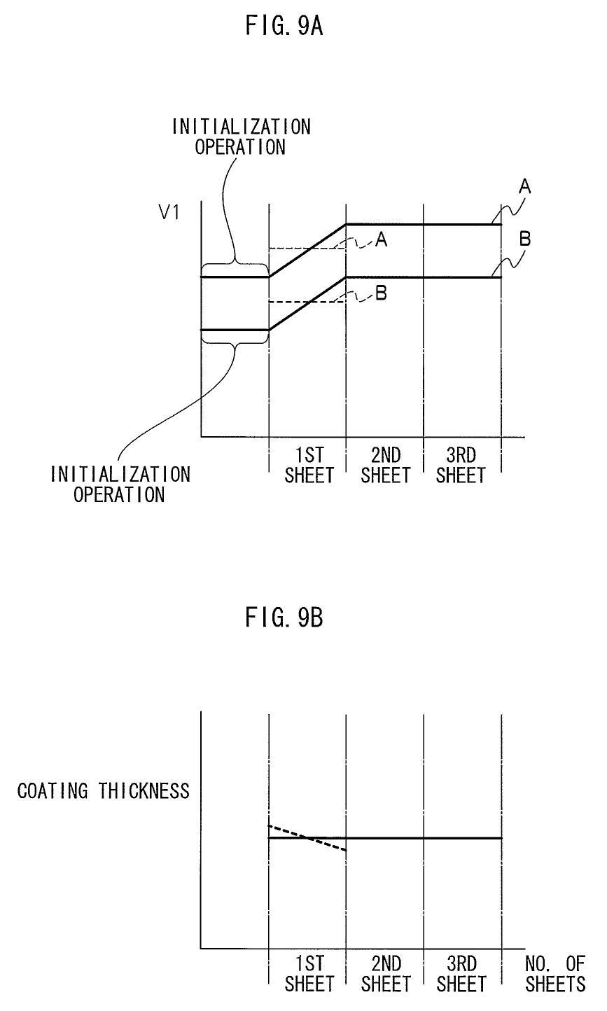

FIGS. 9A and 9B are graphs showing a comparison of the coating thickness (coating amount) of treatment liquid on respective sheets of paper P in a case in which, for paper P having comparatively favorable permeability, the rotational velocity V1 of supply roller 20 is made relatively slow and treatment liquid is applied to plural sheets of the paper P and, for paper P having comparatively poor permeability, the rotational velocity V1 of supply roller 20 is made relatively fast and treatment liquid is applied to plural sheets of the paper P. The vertical axis of FIG. 9A shows the rotational velocity of supply roller 20 and the horizontal axis thereof shows the number of sheets P from the commencement of coating. The vertical axis of FIG. 9B shows the coating thickness (coating amount) on paper P and the horizontal axis thereof shows the number of sheets P from the commencement of coating (the values of the coating thickness and the rotational velocity being relative values). Further, solid line A and broken line A show the rotational velocity V1 of supply roller 20 with respect to paper P having comparatively poor permeability, and solid line B and broken line B show the rotational velocity V1 of supply roller 20 with respect to paper P having comparatively favorable permeability.

As shown in FIG. 8, when both the rotational velocity V1 of supply roller 20 is constant and the amount of treatment liquid supplied is the same, the coating thickness (coating amount) changes for respective types of paper P having different permeability. Specifically, for paper P having favorable permeability the coating thickness increases and for paper P having poor permeability the coating thickness decreases.

Therefore, as shown in FIG. 9A, for paper P having comparatively favorable permeability, the rotational velocity V1 of supply roller 20 is relatively decreased and for paper P having comparatively poor permeability, the rotational velocity V1 of supply roller 20 is relatively increased.

As a result, as shown in FIG. 9B, occurrence of a difference between the coating amount of treatment liquid applied to paper P having comparatively favorable permeability and the coating amount of treatment liquid applied to paper P having comparatively poor permeability is inhibited, whereby variation in the coating amount of treatment liquid applied to paper P can be suppressed.

Examples of paper P having comparatively favorable permeability include C2 paper manufactured by Fuji Xerox Co., Ltd. and New Age paper manufactured by the Oji Paper Co., Ltd., and examples of paper P having comparatively poor permeability include Tokubishi Art paper manufactured by Mitsubishi Paper Mills Limited and OK Topcoat paper manufactured by the Oji Paper Co., Ltd.

Further, the velocity of supply roller 20 with respect to the first sheet of paper P may be kept constant as shown by the broken lines in FIG. 9A, or the velocity of supply roller 20 with respect to the first sheet of paper P may be gradually increased as shown by the solid lines in FIG. 9A.

Configuration having Plural Rollers for Supplying Treatment Liquid to Transport Drum 12

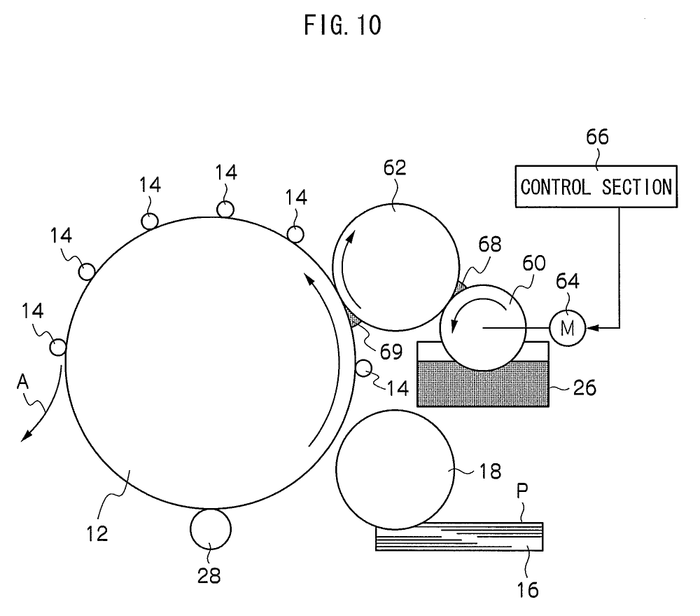

As shown in FIG. 10, a configuration may be adopted in which plural rollers are provided for supplying the treatment liquid stored in reservoir 26 to transport drum 12. Further, identical elements to those in the configuration shown in FIG. 1 are assigned the same reference numerals and explanation thereof is omitted.

In this configuration, in order to apply treatment liquid to the paper P that is being conveyed by transport drum 12, supply roller 60, which rotates to supply treatment liquid toward transport drum 12, and intermediate roller 62, which supplies treatment liquid, which has been supplied by supply roller 60, to transport drum 12, are provided.

Supply roller 60 is provided with drive motor 64, which is a driving section that drives supply roller 60. Supply roller 60 is imparted with drive force by drive motor 64 and rotates. Drive motor 64 is connected to control section 66, which controls the driving, and control section 66 controls the rotational velocity of supply roller 60 by controlling the drive motor 64. Treatment liquid is supplied to supply roller 60 by immersion of supply roller 60 in the treatment liquid in reservoir 26 and absorption of the treatment liquid in reservoir 26 by supply roller 60.

Supply roller 60 rotates in contact with intermediate roller 62 and supplies treatment liquid to intermediate roller 62. Specifically, liquid well 68 is formed by the treatment liquid between supply roller 60 and intermediate roller 62 and treatment liquid is supplied to liquid well 68.

Intermediate roller 62 is disposed between supply roller 60 and transport drum 12. Intermediate roller 62 rotates in contact with transport drum 12, the rotation of intermediate roller 62 being driven by transport drum 12, and supplies treatment liquid to transport drum 12. Specifically, liquid well 69 is formed by the treatment liquid between intermediate roller 62 and transport drum 12 and treatment liquid is supplied to liquid well 69. Treatment liquid is applied to paper P as a result of the passage of paper P through liquid well 69.

In this configuration, an initialization operation is first performed by supply roller 60 and intermediate roller 62. Further, while an initialization operation by intermediate roller 62 is indispensable, an initialization operation by supply roller 60 is not essential, and a configuration may be adopted in which supply roller 60 does not perform an initialization operation.

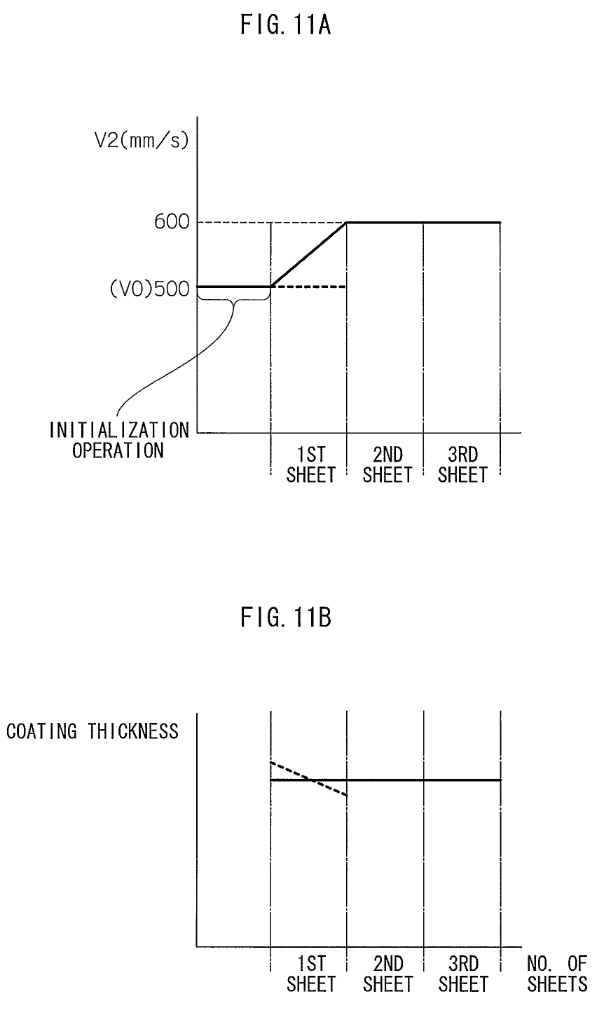

As shown in FIG. 11A, the rotational velocity V2 of supply roller 60 with respect to the first sheet of paper P after the commencement of coating is set to be equal to the conveyance velocity V0 of transport drum 12, and the rotational velocity V2 of supply roller 60 with respect to the second and subsequent sheets of paper P is set to be faster than the conveyance velocity V0 of transport drum 12. Further, in FIG. 11A, the rotational velocity V2 of supply roller 60 with respect to the first sheet of paper P after the commencement of coating is shown with a broken line.

Specifically, for example: V2 (first sheet)=500 mm/s; V2 (second sheet)=V2 (third sheet)=[and so forth]=600 mm/s; and V0=500 mm/s.

Further, as shown by the solid line in FIG. 11A, the velocity of supply roller 60 with respect to the first sheet of paper P after the commencement of coating may be gradually increased.

Here, explanation is given of the relationship between the conveyance velocity (rotational velocity) V0 of transport drum 12, the rotational velocity V1 of intermediate roller 62 and the rotational velocity V2 of supply roller 60.

When the velocity of the roller to which treatment liquid is supplied is faster than that of the roller supplying the treatment liquid, there is a risk that there will be an insufficient supply of treatment liquid, causing a liquid deficit and resulting in variation in the coating amount applied to paper P. Accordingly, the relationship V0≦V1≦V2 is observed As regards the relationship V1>V0, particularly when coating is performed with respect to paper of which the rear end is not held, there are times when intermediate roller 62 rolls up the paper P that is being conveyed by transport drum 12 resulting in waves being formed in paper P. Accordingly, the relationship V0=V1<V2 is observed.

In order to prevent a situation where V1 becomes larger than V0 as a result of a minor change in velocity, the rotation of intermediate roller 62 is driven by transport drum 12.

In order to avoid V1 becoming equal to V2, contact pressure P1 of intermediate roller 62 with respect to transport drum 12 is made larger than contact pressure P2 of supply roller 60 with respect to intermediate roller 62.

In this way, by controlling the rotational velocity V1 of intermediate roller 62 and the rotational velocity V2 of supply roller 60, it is possible to inhibit the occurrence of a disparity between the amount of treatment liquid applied to the first sheet of paper P after commencement of coating and the amount of treatment liquid applied to the second sheet of paper P after commencement of coating. As a result, variation in the coating amount of treatment liquid applied to paper P can be suppressed. In addition, the occurrence of coating unevenness caused by liquid deficit and the formation of waves in paper P are suppressed.

### Configuration for Reverse Rotation of Supply Roller 20

Next, a configuration for reverse rotation of supply roller 20 is explained.

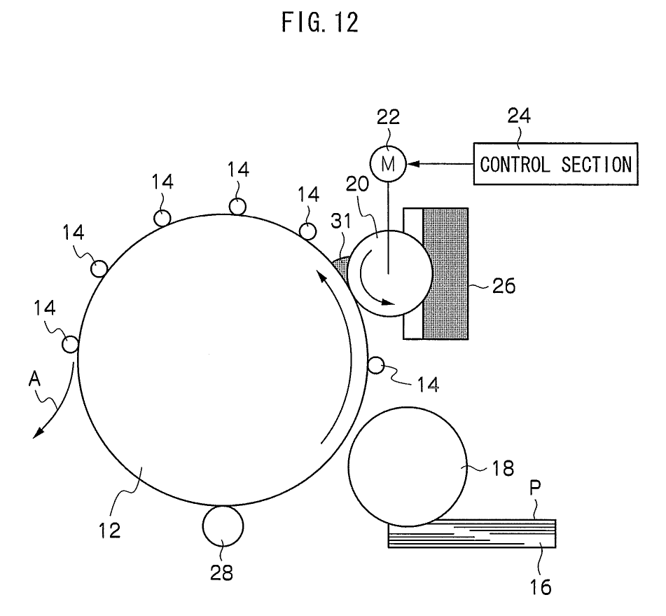

In this configuration, as shown in FIG. 12, supply roller 20, which is imparted with drive force from drive motor 22, rotates in the same direction as transport drum 12. That is, as transport drum 12 in FIG. 1 rotates in an anticlockwise direction, supply roller 20 also rotates in an anticlockwise direction. As a result, supply roller 20 rotates in the opposite direction to the conveyance direction of paper P.

With this rotational configuration, since supply roller does not roll up paper P, waves are not formed in paper P and, therefore, it is possible to make the rotational velocity V1 of supply roller 20 faster than the conveyance velocity (rotational velocity) V0 of transport drum 12.

As a result, the occurrence of coating unevenness caused by liquid deficit and the formation of waves in paper P are suppressed.

Further, with this rotational configuration, the trends shown in FIGS. 2A, 2B, 3A, 3B and 4 are unchanged, and the rotational velocity of supply roller 20 is controlled so as to make the rotational velocity V1 when applying treatment liquid to the first sheet of paper P after commencement of coating slower than the rotational velocity V1 when applying treatment liquid to the second sheet of paper P after commencement of coating, whereby variation in the coating amount of treatment liquid applied to paper P can be suppressed.

### Configuration for Detecting Amount of Liquid in Liquid Well 30

Next, explanation is given of a configuration for detecting the amount of liquid in liquid well 30.

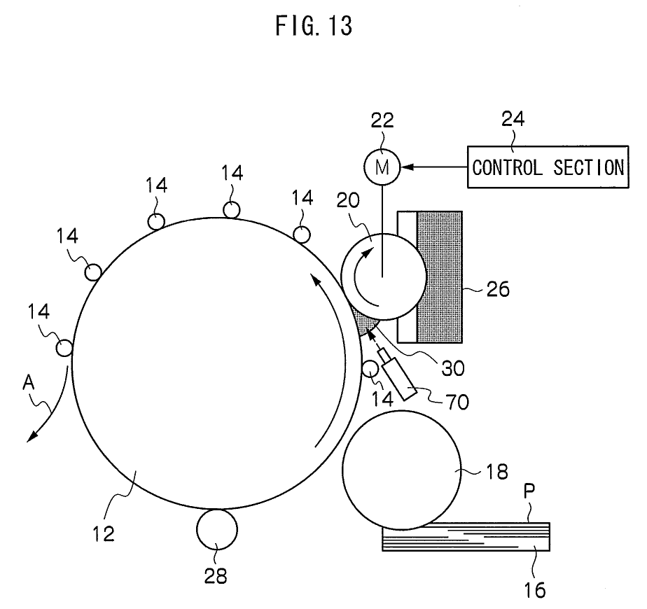

In this configuration, as shown in FIG. 13, detection sensor 70 is provided, which is one example of a detection instrument that detects the amount of liquid of the treatment liquid in liquid well 30.

Detection sensor radiates an infrared ray towards liquid well 30, receives reflected light therefrom, and detects the position (height) of the liquid surface based on the strength of the reflected light, thereby detecting the amount of liquid in liquid well 30. That is, when there is a larger amount of liquid in liquid well 30 (when the position of the liquid surface is higher), the position at which the infrared ray is reflected at the liquid surface becomes higher and the relative strength of the reflected light increases, and when there is a smaller amount of liquid in liquid well 30 (when the position of the liquid surface is lower), the position at which the infrared ray is reflected at the liquid surface becomes lower and the relative strength of the reflected light decreases.

When there is a larger amount of liquid in liquid well 30, the coating amount of treatment liquid applied to paper P also increases. When the amount of liquid in liquid well 30 is detected by detection sensor 70 and the rotational velocity V1 of supply roller 20 is controlled in accordance with the detection result, coating can be performed with high precision. For example, when there is a reduced amount of liquid in liquid well 30, control section 24 relatively increases the rotational velocity V1 of supply roller 20 and when there is an increased amount of liquid in liquid well 30, control section 24 relatively decreases the rotational velocity V1 of supply roller 20.

The present invention is not limited to the foregoing exemplary embodiments and a variety of modifications and improvements are possible.

What is claimed is:

1. A coating mechanism, comprising:
a transport body that conveys a coating target; and
a supply roller that rotates and supplies a treatment liquid toward the transport body in order to apply the treatment liquid to the coating target conveyed by the transport body,
the supply roller performing an initialization operation prior to commencement of application of the treatment liquid by rotating and forming a liquid film of the treatment liquid on a surface of the supply roller, and a rotational velocity of the supply roller when applying the treatment liquid to a first coating target subsequent to the commencement of application of the treatment liquid being slower than a rotational velocity of the supply roller when applying the treatment liquid to a second coating target subsequent to the commencement of application of the treatment liquid.

2. The coating mechanism of claim 1, wherein the rotational velocity of the supply roller when applying the treatment liquid to the first coating target subsequent to the commencement of application of the treatment liquid gradually increases.

3. The coating mechanism of claim 1, wherein the rotational velocity of the supply roller varies in accordance with the permeability of the coating target with respect to the treatment liquid.

4. The coating mechanism of claim 1, wherein the supply roller rotates in the opposite direction to a direction of conveyance of the coating target and supplies the treatment liquid to the transport body and the rotational velocity of the supply roller is faster than a conveyance velocity of the transport body.

5. The coating mechanism of claim 1, further comprising a detector that detects the amount of treatment liquid in a liquid well formed between the transport body and the supply roller, wherein the rotational velocity of the supply roller changes in accordance with the amount of treatment liquid in the liquid well detected by the detector.

6. The coating mechanism of claim 1, wherein the supply roller is disposed so as to rotate in contact with the coating target placed on the transport body.

7. The coating mechanism of claim 1, further comprising an intermediate roller disposed between the transport body and the supply roller, which rotates in accordance with conveyance of the coating target and supplies the treatment liquid, which is supplied from the supply roller, to the transport body.

8. A droplet jetting device comprising the coating mechanism of claim 1.

9. A coating mechanism, comprising:
a transport body that conveys a coating target;
a supply roller that rotates and supplies a treatment liquid toward the transport body in order to apply the treatment liquid to the coating target conveyed by the transport body; and
an intermediate roller disposed between the transport body and the supply roller and that supplies the treatment liquid, which is supplied from the supply roller, to the transport body,
the intermediate roller performing an initialization operation prior to commencement of application of the treatment liquid by rotating and forming a liquid film of the treatment liquid on a surface of the intermediate roller, and a rotational velocity of the intermediate roller being slower than a rotational velocity of the supply roller, and
a rotational velocity of the supply roller when applying the treatment liquid to a first coating target subsequent to the commencement of application of the treatment liquid being slower than a rotational velocity of the supply roller when applying the treatment liquid to a second coating target subsequent to the commencement of application of the treatment liquid.

10. The coating mechanism of claim 9, wherein the intermediate roller rotates in a direction of conveyance of the coating target.

11. The coating mechanism of claim 9, wherein the supply roller is disposed so as to rotate in contact with the intermediate roller.

12. The coating mechanism of claim 9, wherein the supply roller is disposed at a distance from the coating target placed on the transport body.

13. The coating mechanism of claim 9, wherein the rotational velocity of the supply roller when applying the treatment liquid to the first coating target subsequent to the commencement of application of the treatment liquid gradually increases.

14. The coating mechanism of claim 9, wherein the rotational velocity of the supply roller varies in accordance with the permeability of the coating target with respect to the treatment liquid.

15. A droplet jetting device comprising the coating mechanism of claim 9.
